(19) United States
(12) Patent Application Publication
(10) Pub. No.: US 2014/0114718 A1
(43) Pub. Date: Apr. 24, 2014

(54) METHODS, APPARATUSES AND COMPUTER PROGRAM PRODUCTS FOR AUTOMATING ARRIVALS AND DEPARTURES

(71) Applicant: United Parcel Service of America, Inc., Atlanta, GA (US)

(72) Inventors: Philip M. Randall, Louisville, KY (US); Jeff A. Moore, Prospect, KY (US)

(73) Assignee: United Parcel Service of America, Inc., Atlanta, GA (US)

(21) Appl. No.: 14/057,688

(22) Filed: Oct. 18, 2013

Related U.S. Application Data
(60) Provisional application No. 61/715,955, filed on Oct. 19, 2012.

(51) Int. Cl. G06Q 10/08

(52) U.S. Cl. CPC G06Q 10/08
USPC 705/7.23

(57) ABSTRACT

An apparatus is provided for facilitating automated arrival and departure events at a facility. The apparatus may include at least one memory and at least one processor configured to receive an indication identifying one or more loads of a vehicle in response to the vehicle arriving at a facility. The processor is further configured to automatically assign the loads of the vehicle to one or more respective storage locations of the facility in response to receipt of the indication. The processor is further configured to enable provision of another indication to a communication device associated with the vehicle indicating the respective storage locations to place the corresponding loads. Corresponding computer program products and methods are also provided.

### CROSS-REFERENCE TO RELATED APPLICATIONS

This application claims priority to U.S. Provisional Application No. 61/715,955 filed Oct. 19, 2012, which is hereby incorporated herein in its entirety by reference.

### TECHNOLOGICAL FIELD

Exemplary embodiments of the invention relate generally to methods, apparatuses and computer program products for automating arrival and departure events associated with dispatch activities.

### BACKGROUND

Hours of valuable time are consumed everyday as transportation personnel contact dispatchers or others regarding their arrival and departure to areas such as hubs. Such processes may cause reduced productivity as the vehicles may need to come to a complete stop and be turned off to allow the transportation employee to use a telephone to speak with appropriate personnel such as a dispatcher to determine where loads should be placed in a hub. For instance, at present, dispatchers may need to manually assign a bay(s) for transportation personnel (e.g., a driver) to place a load(s) being carried by a vehicle.

In this regard, currently, dispatch operations typically require excessive time as well as staffing resources to manage the activities surrounding the arrivals, departures and pre-dispatch of loads at hubs.

As such, a need may exist for automating arrival and departure dispatch activities.

### BRIEF SUMMARY

In general, embodiments of the present invention provide methods, apparatuses, systems, computing devices, computing entities, and/or the like for automating arrival and departure events associated with dispatch activities.

In order to improve the efficiency of dispatch operations, the exemplary embodiments may automate arrival and departure processes to reduce or eliminate telephone conversations with drivers thus reducing the hours associated with these events pertaining to dispatch services. The exemplary embodiments may also facilitate automation of the pre-dispatch functions to allow a dispatcher to plan ahead and reduce or eliminate the verbal and/or written communication with drivers of vehicles.

In addition, the exemplary embodiments may facilitate automation of assignment of storage locations (e.g., bays) for placement of loads transported by a vehicle(s) of a driver(s) to reduce or eliminate verbal communications with a dispatcher.

In one example embodiment, a method for facilitating automated arrival and departure events at a facility is provided. The method may include receiving an indication identifying one or more loads of a vehicle in response to the vehicle arriving at a facility. The method may further include automatically assigning the loads of the vehicle to one or more respective storage locations of the facility in response to receipt of the indication. The method may further include enabling provision of another indication to a communication device associated with the vehicle indicating the respective storage locations to place the corresponding loads.

In another example embodiment, an apparatus for facilitating automated arrival and departure events at a facility is provided. The apparatus may include a processor and memory including computer program code. The memory and the computer program code are configured to, with the processor, cause the apparatus to at least perform operations including receiving an indication identifying one or more loads of a vehicle in response to the vehicle arriving at a facility. The memory and computer program code are further configured to, with the processor, cause the apparatus to automatically assign the loads of the vehicle to one or more respective storage locations of the facility in response to receipt of the indication. The memory and computer program code are further configured to, with the processor, cause the apparatus to enable provision of another indication to a communication device associated with the vehicle indicating the respective storage locations to place the corresponding loads.

In yet another example embodiment, a computer program product for facilitating automated arrival and departure events at a facility is provided. The computer program product includes at least one computer-readable storage medium having computer-executable program code instructions stored therein. The computer-executable program code instructions may include program code instructions configured to facilitate receipt of an indication identifying one or more loads of a vehicle in response to the vehicle arriving at a facility. The program code instructions may also be configured to automatically assign the loads of the vehicle to one or more respective storage locations of the facility in response to receipt of the indication. The program code instructions may also be configured to enable provision of another indication to a communication device associated with the vehicle indicating the respective storage locations to place the corresponding loads.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a diagram of a system that may be used to practice various exemplary embodiments of the invention;

FIG. 2 is a schematic diagram of a carrier communication device in accordance with certain exemplary embodiments of the invention;

FIG. 3 is a schematic diagram of a mobile device in accordance with an exemplary embodiment of the invention;

FIG. 4 is a diagram illustrating mobile assets entering and exiting an exemplary hub facility; and

FIG. 5 is a flowchart illustrating operations and processes that may be used in accordance with various exemplary embodiments of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

### I. Exemplary System Architecture

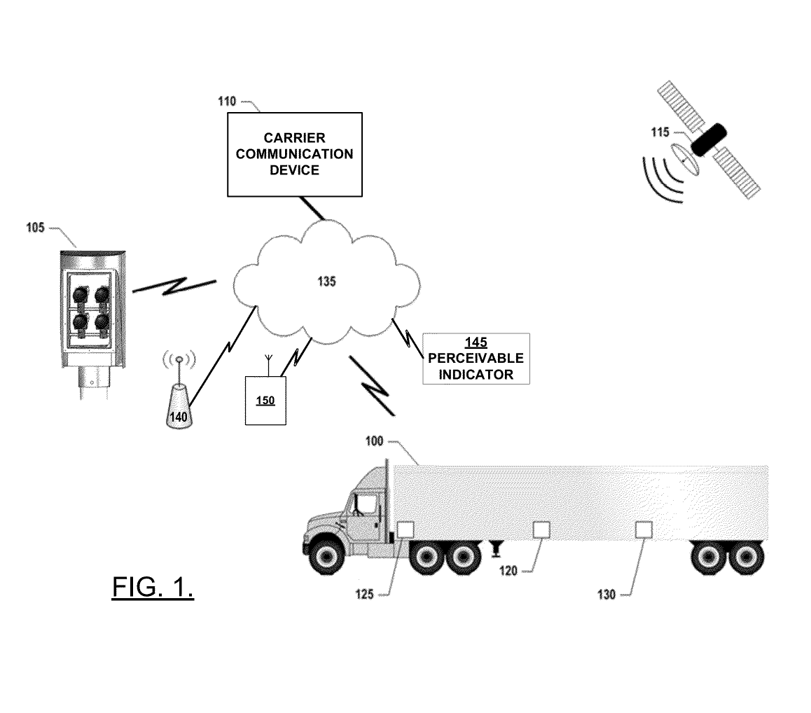

The system may include one or more mobile assets 100, one or more imaging devices 105, one or more carrier communication devices 110, one or more Global Positioning System (GPS) satellites 115, one or more networks 135, one or more radio frequency identification (RFID) readers/interrogators 140, one or more perceivable indicators 145, one or more mobile devices 150, and/or the like. The mobile assets 100 may be operated by an operator, also referred to herein as a personnel asset (e.g., a driver(s)). Thus, both mobile assets 100 and personnel assets are “assets.” Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

a. Exemplary Mobile Asset

In various embodiments, a mobile asset 100 may be a tractor, a truck, a car, a motorcycle, a moped, a Segway, a trailer, a tractor and trailer combination, a van, a flatbed truck, a delivery vehicle, and/or any other form of vehicle. In one embodiment, each mobile asset 100 may be associated with a unique mobile asset identifier (such as a mobile asset ID) that uniquely identifies the mobile asset 100. The mobile asset 100 may be mobile in the sense that it may be able to move from one location to another under its own power. The unique mobile asset ID may include characters, such as numbers, letters, symbols, and/or the like. For example, an alphanumeric mobile asset ID (e.g., “1221A445533AS445”) may be associated with each mobile asset 100. In another embodiment, the unique mobile asset ID may be the license plate, registration number painted or stickered on the mobile asset 100, or other identifying information assigned to and visible on the mobile asset 100. FIG. 1 represents an embodiment in which the mobile asset 100 is a tractor, a trailer, or a tractor and trailer combination (also referred to herein as tractor-trailer).

FIG. 1 shows one or more computing entities, devices, and/or similar words used herein interchangeably that are associated with the mobile asset 100, such as an information/data collection device 130 or other computing entities. The data collection device 130 that may be attached, affixed, disposed upon, integrated into, or part of a mobile asset 100. The information/data collection device 130 may collect location and telematics information/data and transmit/send the information/data to the mobile device 150, and/or the carrier communication device 110.

In one embodiment, each mobile asset 100 may have an RFID tag/sensor attached or affixed thereto that stores the corresponding mobile asset ID. Such an RFID tag/sensor may be placed inside a mobile asset 100, or affixed to an outer surface of a mobile asset 100, for example. The RFID tags/sensors may be passive RFID tags/sensors, active RFID tags/sensors, semi-active RFID tags/sensors, battery-assisted passive RFID tags/sensors, and/or the like. Thus, the RFID tags/sensors may include some or all of the following components: one or more input interfaces for receiving information/data, one or more output interfaces for transmitting information/data, a processor, a clock, memory modules, and a power source.

In another embodiment, each mobile asset 100 may have its corresponding mobile asset ID visible on the exterior of the mobile asset 100. For example, the license plate number, registration number, alphanumeric characters, or other identifying information may be on the exterior of the mobile asset such that one or more imaging devices can capture an image of the mobile asset ID and properly identify it via analysis.

b. Exemplary Carrier Communication Device

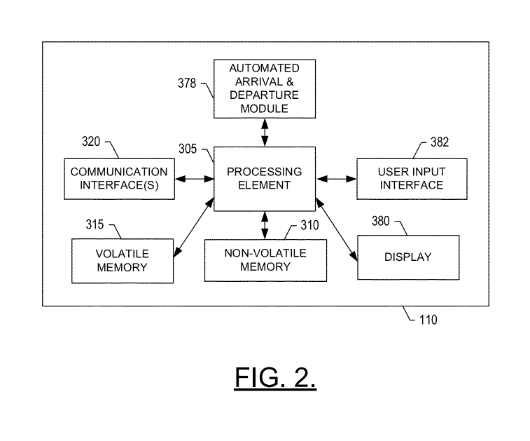

FIG. 2 provides a schematic of a carrier communication device 110 (also referred to herein as Hub & Feeder Control System (HFCS) 110) according to an example embodiment. In general, the term communication device may refer to, for example, one or more computers, computing devices, computing entities, mobile phones, desktops, tablets, notebooks, laptops, distributed systems, servers, network devices, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the carrier communication device 110 may also include one or more communications interfaces 320 for communicating with various computing entities, such as by communicating data, content, information, and/or similar terms used herein interchangeably that can be transmitted, received, operated on, processed, displayed (e.g., via display 380), stored, and/or the like. For instance, the carrier communication device 110 may communicate with mobile assets 100, imaging devices 105, RFID interrogators/readers 140, mobile devices 150, and/or the like.

As shown in FIG. 2, in one embodiment, the carrier communication device 110 may include or be in communication with one or more processing elements 305 (also referred to as processors, processing circuitry, and/or similar terms used herein interchangeably) that communicate with other elements within the carrier communication device 110 via a bus, for example. As will be understood, the processing element 305 may be embodied in a number of different ways. For example, the processing element 305 may be embodied as one or more complex programmable logic devices (CPLDs), microprocessors, multi-core processors, coprocessing entities, application-specific instruction-set processors (ASIPs), and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present invention when configured accordingly.

In one example embodiment, the carrier communication device 110 may further include or be in communication with non-volatile memory 310 (also referred to as non-volatile storage, memory, memory storage, memory circuitry and/or similar terms used herein interchangeably). In one embodiment, the non-volatile storage or memory may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database carrier systems, information/data, applications, programs, program modules, scripts, source code, object code, byte code, compiled code, interpreted code, machine code, executable instructions, and/or the like. The term database, database instance, database carrier system, and/or similar terms used herein interchangeably may refer to a structured collection of records or information/data that is stored in a computer-readable storage medium, such as via a relational database, hierarchical database, and/or network database.

In one example embodiment, the carrier communication device 110 may further include or be in communication with volatile memory 315 (also referred to as volatile storage, memory, memory storage, memory circuitry and/or similar terms used herein interchangeably). In one example embodiment, the volatile memory 315 may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database carrier systems, information/data, applications, programs, program modules, scripts, source code, object code, byte code, compiled code, interpreted code, machine code, executable instructions, and/or the like being executed by, for example, the processing element 305. Thus, the databases, database instances, database carrier systems, information/data, applications, programs, program modules, scripts, source code, object code, byte code, compiled code, interpreted code, machine code, executable instructions, and/or the like may be used to control certain aspects of the operation of the carrier communication device 110 with the assistance of the processing element 305 and operating system.

As indicated, in one example embodiment, the carrier communication device 110 may also include one or more communications interfaces 320 for communicating with various computing entities, such as by communicating information/data, content, information, and/or similar terms used herein interchangeably that can be transmitted, received, operated on, processed, displayed, stored, and/or the like. For instance, the carrier communication device 110 may communicate with computing entities or communication interfaces of the mobile asset 100 (e.g., tractor, trailer, tractor and/or trailer, delivery vehicle), the imaging devices 105, RFID interrogators/readers 140, mobile devices 150, and/or the like.

Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the carrier communication device 110 may be configured to communicate via wireless external communication networks using any of a variety of protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. Although not shown, the carrier communication device 110 may include or be in communication with one or more input elements, such as a keyboard input, a mouse input, a touch screen/display input, audio input, pointing device input, joystick input, keypad input, and/or the like. The carrier communication device 110 may also include or be in communication with one or more output elements (not shown), such as audio output, video output, screen/display output, motion output, movement output, and/or the like.

In addition to the communication interface(s), the interface(s) may also include at least one user interface that may include one or more earphones and/or speakers, a display 380, and/or a user input interface 382. The user input interface, in turn, may comprise any of a number of devices allowing the carrier communication device to receive data from a user, such as a microphone, a keypad, keyboard, a touch display, a joystick, image capture device, pointing device (e.g., mouse), stylus or other input device.

As will be appreciated, one or more of the components of the carrier communication device 110 may be located remotely from other components of the carrier communication device 110, such as in a distributed system. Furthermore, one or more of the components may be combined and additional components performing functions described herein may be included in the carrier communication device 110. Thus, the carrier communication device 110 may be adapted to accommodate a variety of needs and circumstances.

In an exemplary embodiment, the processing element 305 may be in communication with and may otherwise control an automated arrival and departure (AAD) module 378. The AAD module 378 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the AAD module 378, as described below. In one example embodiment, the AAD module may, but need not, be employed in a special purpose chip such as, for example, an application-specific integrated circuit (ASIC) or a field-programmable gate array (FPGA). In examples in which software is employed, a device or circuitry (e.g., processing element 305 in one example) executing the software forms the structure associated with such means. As such, for example, the AAD module 378 may be configured to, among other things, receive load information from mobile assets (e.g., tractor-trailers) entering a hub facility (e.g., a warehouse, a storage facility, a load transfer facility, etc.) and may automatically assign loads of the mobile assets for placement or storage in designated areas (e.g., storage areas (e.g., bays)) of the hub facility. The AAD module 378 may also automatically verify that mobile assets are ready for departure from a hub. For instance, the AAD module 378 may verify or validate that the equipment of a mobile asset(s) is functioning properly prior to departure from the hub facility. In addition, the AAD module 378 may facilitate changes to a schedule of a driver(s) of a mobile asset(s) and may communicate the schedule changes (e.g., wirelessly via network 135) to a mobile device(s) (e.g., mobile device 150) of the driver(s) such that the driver(s) may not need to manually communicate with a dispatcher (e.g., calling the dispatcher via a telephone) regarding the schedule changes.

Moreover, the AAD module 378 may assign one or more pre-dispatch loads for one or more drivers of mobile assets prior to departure of the mobile assets from the hub facility and may communicate (e.g., wirelessly via network 135) the pre-dispatch load information to the mobile devices of the drivers to enable the drivers to receive the pre-dispatch load information without requiring the drivers to manually communicate with a dispatcher (e.g., calling the dispatcher via a telephone), as described more fully below.

As will be appreciated, one or more of the carrier communication device's 110 components may be located remotely from other carrier communication device's 110 components, such as in a distributed system. Furthermore, one or more of the components may be combined and additional components performing functions described herein may be included in the carrier communication device 110. Thus, the carrier communication device 110 may be adapted to accommodate a variety of needs and circumstances.

c. Exemplary Mobile Device

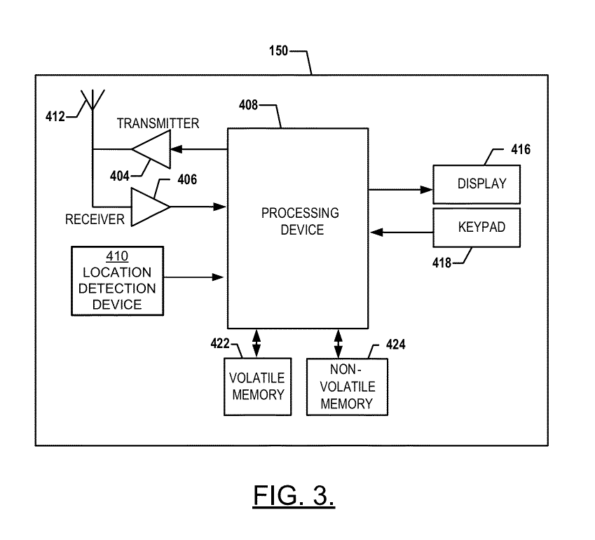

FIG. 3 provides an illustrative schematic representative of a mobile device 150 (e.g., a mobile computing entity) (also referred to herein as a feeder data terminal (FDT) 150) that may be used in conjunction with embodiments of the present invention. The device is mobile in the sense that it may be easily moved from one location to another. Mobile devices 150 may be operated by various parties, including operators of mobile assets 100 (e.g., personnel assets (e.g., drivers)). As shown in FIG. 3, the mobile device 150 may include an antenna 412, a transmitter 404 (e.g., radio), a receiver 406 (e.g., radio), and a processing element 408 that provides signals to and receives signals from the transmitter 404 and receiver 406, respectively.

The signals provided to and received from the transmitter 404 and the receiver 406, respectively, may include signaling information/data in accordance with an air interface standard of applicable wireless systems to communicate with various entities, such as mobile assets 100, imaging devices 105, carrier communication device 110, RFID interrogators/readers 140, and/or the like. In this regard, the mobile device 150 may be capable of operating with one or more air interface standards, communication protocols, modulation types, and access types. More particularly, the mobile device 150 may operate in accordance with any of a number of wireless communication standards and protocols. In a particular embodiment, the mobile device 150 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 150 may communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The mobile device 150 may also download changes, add-ons, and updates, for instance, to its firmware, software (e.g., including executable instructions, applications, program modules), and operating system.

According to one embodiment, the mobile device 150 may include a location determining device 410 (also referred to herein as location detection device 410) and/or functionality. For example, the location detection device 410 may include a GPS module adapted to acquire, for example, latitude, longitude, altitude, geocode, course, and/or speed data (e.g., speed data of mobile asset 100). In one embodiment, the location detection device 410 may acquire information/data, sometimes known as ephemeris information/data, by identifying the number of satellites in view and the relative positions of those satellites.

The mobile device 150 may also comprise a user interface (that may include a display 416 coupled to a processing element 408) and/or a user input interface (coupled to a processing element 408 (also referred to herein as processing device 408)). The user input interface can comprise any of a number of devices allowing the mobile device 150 to receive information/data, such as a keypad 418 (hard or soft), a touch display, voice or motion interfaces, or other input device. In embodiments including a keypad 418, the keypad 418 can include (or cause display of) the conventional numeric (0-9) and related keys (#, *), and other keys used for operating the mobile device 150 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 150 can also include volatile storage or memory 422 and/or non-volatile storage or memory 424, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the mobile device 150.

d. Perceivable Indicators

Embodiments of the invention may also use one or more perceivable indicators 145 positioned at hubs, staging areas, customs areas, checkpoint areas, and/or the like. A perceivable indicator 145 may be one or more stop lights (e.g., with red, yellow, and green lights), a beacon (e.g., a light that flashes), and/or one or more audible sound generators (e.g., that generate a honking, bell, or alarm sound). A perceivable indicator may also be one or more message boards (such as liquid crystal display (LCD) or light-emitting diode (LED) message boards) that provide specific instructions, such as dock number, safety tip, road closure information, traffic alert, and/or weather related information, and/or the like. A perceivable indicator 145 may also be a locking gate or boom barrier gate with an appropriate engagement or retraction. Accordingly, in addition to providing a perceivable indication, the perceivable indicator 145 may also provide an obstacle for preventing access to or from staging areas, customs areas, checkpoint areas, and/or the like.

In one embodiment, the perceivable indications provided or generated by the one or more perceivable indicators 145 may be initiated and/or terminated by receiving instructions from an appropriate computing entity, such as RFID readers/interrogators 140, mobile assets 100, imaging devices 105, carrier communication devices 110, mobile devices 150, and/or the like. Such instructions may be received using a variety of wired or wireless technologies and protocols, including FDDI, DSL, Ethernet, ATM, frame relay, DOCSIS, or any other wired transmission protocol, GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, USB protocols, and/or any other wireless protocol.

### II. Exemplary System Operation

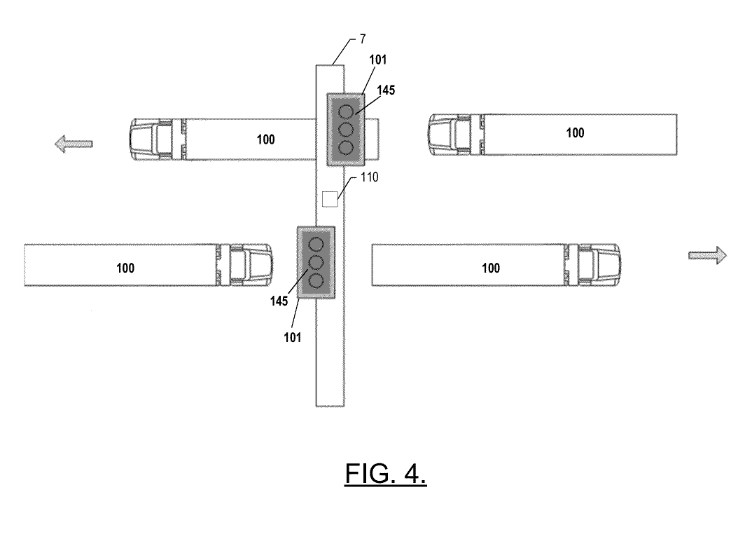

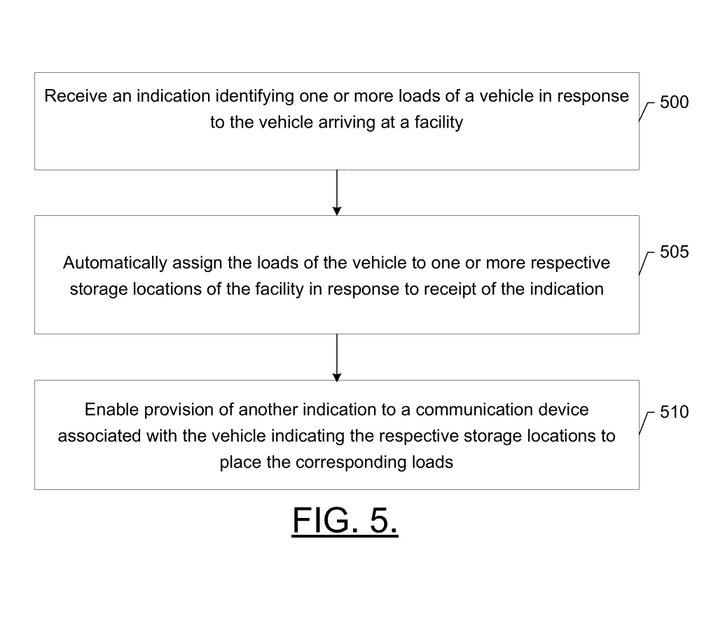

Reference will now be made to FIG. 4 which shows mobile assets 100 entering and exiting an exemplary hub 7 (also referred to herein as hub facility 7) (e.g., an origin hub, an intermediate location hub, a destination hub, a staging area, a customs area, a checkpoint area, and/or the like). FIG. 5 is a flowchart illustrating operations and processes that may be used in accordance with various embodiments of the invention.

a. Automating Arrival Events

In one example embodiment, a carrier communication device 110 may be maintained at a hub facility 7. In this regard, in an instance in which a mobile asset 100 (e.g., a tractor-trailer) enters an arrival-departure point 101 of the hub facility 7, the feeder data terminal 150 of a driver may send an indication to the carrier communication device 110 (also referred to herein as HFCS 110) indicating that the mobile asset 100 arrived at the hub facility 7 in response to receipt of a selection by the driver of the mobile asset 100. In an alternative example embodiment, a perceivable indicator 145 positioned at an arrival-departure point 101 of the hub facility 7 may detect the arrival of the mobile asset 100 and may inform the HFCS 110 of the arrival of the mobile asset 100.

The feeder data terminal 150 of a driver of a mobile asset 100 may store (e.g., in the non-volatile memory 424, and/or volatile memory 422) load information indicating, for example, origin location and/or destination location of the mobile asset 100, load name (e.g., the origin of a trailer(s), the destination of the trailer(s)), trailer numbers (e.g., front trailer number, rear trailer number) and load data (e.g., items of the load(s)) associated with trailers of the mobile asset 100, a dolly number(s), telematics data and any other suitable information. The dolly may connect two trailers (e.g., a front trailer and a rear trailer, etc.) of a mobile asset 100.

In one example embodiment, the load information may be detected and stored by the feeder data terminal 150 in response to detecting a scanned barcode associated with a trailer(s) (e.g., front trailer, rear trailer) of the mobile asset 100 that is linked to the load information. In another example embodiment, the feeder data terminal 150 may store the load information in response to receipt of input by a user (e.g., a driver) entering the information in the feeder data terminal 150.

In this regard, the feeder data terminal 150 may send (e.g., wirelessly via network 135) the load information to the HFCS 110 upon entering an arrival-departure point 101 of the hub facility. The feeder data terminal 150 may send the load information to the HFCS 110 in response to receipt of a selection by a user (e.g., a driver of mobile asset 100) to communicate the load information to the HFCS 110. In response to receipt of the load information, the HFCS 110 may analyze the data, identify one or more trailers (e.g., a front trailer, a rear trailer) associated with the mobile asset 100 and the corresponding load data (e.g., load items (e.g., packages)) for the identified trailers (e.g., front and rear trailers) and the HFCS 110 may automatically assign loads of the identified trailers for placement/storage in specified areas/locations.

For example, for purposes of illustration and not of limitation, consider that the mobile asset 100 has two trailers (e.g., front and rear trailers). In this regard, the HFCS 110 may receive and analyze the load information associated with the two trailers and may automatically assign each of the trailers to available bays of the hub facility 7. For instance, the HFCS 110 may automatically assign the front trailer to bay 200 and the rear trailer to bay 225 for placement or storage. As such, the HFCS 110 may communicate (e.g., via network 135) the assignment of the bays (e.g., bay 200 and bay 225) in which to place/store the trailers (e.g., front and rear trailers), of the mobile asset, to the feeder data terminal 150. In response to the feeder data terminal 150 receiving the assignment of the bays from the HFCS 110, the driver of the mobile asset 100 may drive the mobile asset 100 to corresponding bays for placement/storage of the respective trailers at the bays (e.g., front trailer at bay 200, rear trailer at bay 225).

In assigning the trailers to corresponding bays for placement/storage, the HFCS 110 may detect bays that are scheduled to be available for the duration of time needed for placement/storage of the trailers prior to the departure of the trailers, or the load(s) associated with the trailers. The HFCS 110 may also detect bays that were previously assigned, by the HFCS 110, for placement/storage of other trailers in order to detect whether these bays are scheduled to become available within a predetermined amount of time (e.g., within 10 minutes). In an instance in which these previously assigned bays are scheduled to become available upon the expiration of the predetermined time period, the HFCS 110 may assign these bays for the trailers (e.g., the two trailers) of the mobile asset 100 that entered an arrival-departure point 101.

Although the mobile asset 100 had two trailers in the above example, it should be pointed out that the mobile asset 100 may have any other suitable number of trailers (e.g., one trailer, three trailers, etc.) without departing from the spirit and scope of the invention.

In response to the HFCS 110 automatically assigning the bays for placement of trailers, or loads of trailers, of a mobile asset 100, the driver may only need to interact with a dispatcher (e.g., an operator handling dispatch services) in an instance in which an exception condition is detected. An exception condition may be a condition that causes the HFCS 110 to be unable to automatically assign bays for placement/storage of trailers, or loads of a mobile asset 100. For example, for purposes of illustration and not of limitation, in an instance in which information is missing from the load information such as, for example, trailer numbers, load name, the origin or destination information, etc., the HFCS 110 may detect an exception condition and may be unable to automatically assign areas/locations of the hub facility 7 (e.g., a warehouse, a storage facility, a load transfer facility, etc.) for placement/storage of trailers or loads. In one example embodiment, the HFCS 110 may communicate the exception condition to the feeder data terminal 150 of a driver and the driver may call a dispatcher of the hub facility 7 to receive an assignment (e.g., a manual assignment) of a bay(s) in which to place/store a trailer(s)/load(s) of a mobile asset 100.

b. Automating Departure Events & Equipment Validation

In an instance in which a mobile asset 100 is preparing to depart the hub facility 7 via an arrival-departure point 101, the HFCS 110 may communicate with the feeder data terminal 150 to automate the departure of the mobile asset 100. For instance, the feeder data terminal 150 may send the HFCS 110 a message indicating that the mobile asset 100 (e.g., a tractor-trailer) has the trailers (e.g., a front trailer, a rear trailer) or other load(s) assigned by the HFCS 110 for departure. In addition, the feeder data terminal 150 may include information in the message indicating whether equipment (e.g., tires, engine, brakes, etc.) of the mobile asset 100 is functioning properly and/or whether one or more tests (e.g., mechanical and/or electrical tests) passed (e.g., oil pressure, air pressure of tires, etc.). The feeder data terminal 150 may send the message to the HFCS 110 in response to receipt of an indication of a selection (e.g., a selection by the driver, of mobile asset 100, input via the keypad 418) to send the message requesting departure approval to the HFCS 110. In one example embodiment, the driver of the mobile asset 100 may input data into the feeder data terminal 150 indicating whether equipment of mobile asset 100 is functioning properly and/or whether one or more tests passed as part of a pre-departure check in which the driver inspects the equipment of the mobile asset 100 and reviews the tests (e.g., oil pressure measurements, etc.).

In response to analyzing the data of the message and determining that the mobile asset 100 has the assigned trailers and that the equipment of the mobile asset 100 is functioning properly and that tests (e.g., mechanical and/or electrical tests) passed, the HFCS 110 may send the feeder data terminal 150 an indication that the mobile asset 100 is cleared for departure from the hub facility 7 (e.g., via an arrival-departure point 101 of the hub facility 7). In response to receipt of the indication that the mobile asset 100 is cleared for departure, via the feeder data terminal 150, the mobile asset 100 may depart the hub facility 7.

On the other hand, the HFCS 110 may detect an exception condition in an instance in which the message indicates that the mobile asset 100 has at least one trailer that was not assigned to the mobile asset 100 by the HFCS 110 or by a dispatcher of the hub facility 7 and/or indicates that an item(s) of equipment failed, and/or that a test(s) (e.g., mechanical and/or electrical test(s)) failed. In response to detecting the exception condition, the HFCS 110 may provide an indication to the feeder data terminal 150 indicating that the mobile asset 100 is not approved for departure. In this regard, the driver of the mobile asset 100 may need to call a dispatcher of the hub facility 7 to arrange for pickup of the assigned trailer(s) and/or to schedule maintenance to replace failed equipment (e.g., flat tires, brakes, engine parts, etc.) or to address test failures (e.g., detection of low oil pressure, power steering fluid, etc.) prior to being cleared/approved for departure from the hub facility 7.

c. Performance Reporting

In one example embodiment, the HFCS 110 may record or track data indicating the number of automated arrivals and departures from a hub facility (e.g., hub facility 7) during a time period relative to the number of manually facilitated (e.g., arranged in part by a dispatcher) arrivals and departures from the hub facility during the same time period.

In an example embodiment, the HFCS 110 may provide a centralized web service (e.g., a website) that stores this information and may compare the data to target goals with the aim of obtaining a high number or percentage of automated arrivals and departures. The data associated with the manual arrivals/departures stored by the centralized web service, provided by HFCS 110, may include data corresponding to some instances in which outside carriers (e.g., third party carriers) delivering loads or other items to the hub facility may be required to stop and communicate with a dispatcher to arrange for arrival and/or departure.

In one example embodiment, the target goal may be 80-85% of the arrivals being automated and 90% of the departures being automated. The HFCS 110 may provide data to the centralized web service to enable the centralized web service to indicate whether the recorded/tracked data of the detected automated arrivals/departures versus the detected manually facilitated arrival/departures meets the target goals. The HFCS 110 may generate one or more reports indicating statistics pertaining to the detected automated arrivals/departures in comparison to the target goals. The reports may be accessible via the centralized web service provided by the HFCS 110.

d. Schedule Changes & Pre-Dispatch

In one example embodiment, the HFCS 110 may facilitate schedule changes or updates to the previously generated schedules associated with a designated travel path of one or more drivers in response to receipt of input from a user (e.g., a dispatcher). The HFCS 110 may utilize an in vehicle information system (IVIS) schedule and dispatch editor (SADE) to change/update one or more schedules pertaining to travel paths of drivers. The HFCS 110 may provide (e.g., wirelessly via network 135) a schedule change(s) to a feeder data terminal 150 of a driver prior to a driver departing from a hub facility. In this manner, the driver may receive the schedule change pertaining to the updated schedule prior to traveling along a previously designated travel path associated with the prior or initial schedule. In some example embodiments, the HFCS 110 may provide (e.g., wirelessly via network 135) a schedule change(s) to a feeder data terminal 150 of a driver even in an instance in which the driver has departed from a hub facility to indicate to the driver to alter a travel path according to the schedule change.

For purposes of illustration and not of limitation, consider an instance in which a driver's schedule is initially to depart from Lexington, Ky. and travel to Indianapolis, Ind. to deliver two trailers (e.g., trailer 1 and trailer 2). In an instance in which the HFCS 110 detects a change to the initial schedule such as, for example, designating the driver to travel from Lexington, Ky. to Atlanta, Ga. to deliver two trailers, the HFCS 110 may provide this schedule update to the feeder data terminal 150 of the driver so that the driver is informed of the schedule update.

The HFCS 110 may also pre-dispatch load assignments to a driver and may provide (e.g., wirelessly via network 135) the pre-dispatch assignments to the feeder data terminal 150 of a driver. The pre-dispatch load assignments may specify the loads (e.g., loads 1 and 2 on trailers 1 and 2 respectively) that the driver is to deliver along a travel path (e.g., Lexington, Ky. to Atlanta, Ga.).

At present, some existing systems manually assign pre-dispatch loads. By utilizing the HFCS 110 to generate pre-dispatch assignments that may be provided electronically or wirelessly to the feeder data terminal 150 of a driver, a dispatcher may not need to speak with the driver regarding the pre-dispatch load assignment(s) which may save or conserve time and resources.

Referring now to FIG. 5, a flowchart of an example method for facilitating automated arrival and departure events at a facility is provided according to an exemplary embodiment. At operation 500, an apparatus (e.g., HFCS 110) may receive an indication (e.g., a message from feeder data terminal 150) identifying one or more loads of a vehicle (e.g., mobile asset 100 (e.g., a tractor-trailer)) in response to the vehicle arriving at a facility (e.g., hub facility 7). At operation 505, the apparatus (e.g., HFCS 110) may automatically assign the loads (e.g., a load of a front trailer, a load of a rear trailer, etc.) of the vehicle to one or more respective storage locations (e.g., bays (e.g., bay 200, bay 225, etc.)) of the facility (e.g., hub facility 7) in response to receipt of the indication. At operation 510, the apparatus (e.g., HFCS 110) may enable provision (e.g., wirelessly via network 135) of another indication (e.g., a message) to a communication device (e.g., feeder data terminal 150) associated with the vehicle indicating the respective storage locations (e.g., bays (e.g., bay 200, bay 225, etc.)) to place the corresponding loads.

It should be pointed out that FIG. 5 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., non-volatile memory 310, volatile memory 315) and executed by a processor (e.g., processing element 305, automated arrival and departure module 378). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the method of FIG. 5 above may comprise a processor (e.g., processing element 305, automated arrival and departure module 378) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processing element 305 (e.g., as means for performing any of the operations described above), the automated arrival and departure module 378 and/or a device or circuit for executing instructions or executing an algorithm for processing information as described above.

### III. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving an indication identifying one or more loads of a vehicle in response to the vehicle arriving at a facility;
automatically assigning, via a processor, the loads of the vehicle to one or more respective storage locations of the facility in response to receipt of the indication; and
enabling provision of another indication to a communication device associated with the vehicle indicating the respective storage locations to place the corresponding loads.

2. The method of claim 1, wherein enabling provision of the another indication enables a driver of the vehicle to deliver the loads to the respective storage locations for storage of the loads.

3. The method of claim 1, wherein automatically assigning comprises assigning the loads to the storage locations without communicating with personnel of the facility pertaining to assignment of the storage locations.

4. The method of claim 1, wherein:
the storage locations comprise one or more bays of the facility; and
the loads comprise one or more items of one or more trailers.

5. The method of claim 1, further comprising:
receiving a message indicating whether the vehicle has at least one assigned load designated for departure from the facility in response to determining that the vehicle is preparing to depart the facility.

6. The method of claim 5, wherein the message indicates whether one or more items of equipment of the vehicle are functioning properly and whether tests of the vehicle passed.

7. The method of claim 6, further comprising:
automatically authorizing the vehicle to depart with the assigned load from the facility in response to analyzing the message and determining that the vehicle has the assigned load, that the equipment is functioning properly and that the tests of the vehicle passed.

8. The method of claim 1, further comprising:
changing a previously generated schedule of a driver of the vehicle such that a travel path assigned to the driver for delivery of at least one load is changed; and
enabling provision of the changed schedule to the communication device associated with the vehicle to inform the driver of changed schedule.

9. The method of claim 1, further comprising:
assigning at least one pre-dispatch load to a driver of the vehicle, the assigned pre-dispatch load indicates at least one load that the driver is assigned to transport along a designated travel path; and
enabling provision of the assigned pre-dispatch load to the communication device associated with the vehicle to inform the driver of the assigned pre-dispatch load.

10. An apparatus comprising at least one processor and at least one memory including computer program code, the at least one memory and the computer program code configured to, with the processor, cause the apparatus to at least:
receive an indication identifying one or more loads of a vehicle in response to the vehicle arriving at a facility;
automatically assign the loads of the vehicle to one or more respective storage locations of the facility in response to receipt of the indication; and
enable provision of another indication to a communication device associated with the vehicle indicating the respective storage locations to place the corresponding loads.

11. The apparatus of claim 10, wherein enable provision of the another indication enables a driver of the vehicle to deliver the loads to the respective storage locations for storage of the loads.

12. The apparatus of claim 10, wherein the memory and computer program code are further configured to, with the processor, cause the apparatus to:
automatically assign by assigning the loads to the storage locations without communicating with personnel of the facility pertaining to assignment of the storage locations.

13. The apparatus of claim 10, wherein:
the storage locations comprise one or more bays of the facility; and
the loads comprises one or more items of one or more trailers.

14. The apparatus of claim 10, wherein the memory and computer program code are further configured to, with the processor, cause the apparatus to:
receive a message indicating whether the vehicle has at least one assigned load designated for departure from the facility in response to determining that the vehicle is preparing to depart the facility.

15. The apparatus of claim 14, wherein the message indicates whether one or more items of equipment of the vehicle are functioning properly and whether tests of the vehicle passed.

16. The apparatus of claim 15, wherein the memory and computer program code are further configured to, with the processor, cause the apparatus to:
automatically authorize the vehicle to depart with the assigned load from the facility in response to analyzing the message and determining that the vehicle has the assigned load, that the equipment is functioning properly and that the tests of the vehicle passed.

17. The apparatus of claim 10, wherein the memory and computer program code are further configured to, with the processor, cause the apparatus to:
change a previously generated schedule of a driver of the vehicle such that a travel path assigned to the driver for delivery of at least one load is changed; and
enable provision of the changed schedule to the communication device associated with the vehicle to inform the driver of changed schedule.

18. The apparatus of claim 10, wherein the memory and computer program code are further configured to, with the processor, cause the apparatus to:
assign at least one pre-dispatch load to a driver of the vehicle, the assigned pre-dispatch load indicates at least one load that the driver is assigned to transport along a designated travel path; and
enable provision of the assigned pre-dispatch load to the communication device associated with the vehicle to inform the driver of the assigned pre-dispatch load.

19. A computer program product comprising at least one non-transitory computer readable storage medium having computer-executable program code instructions stored therein, the computer-executable program code instructions comprising:
program code instructions configured to facilitate receipt of an indication identifying one or more loads of a vehicle in response to the vehicle arriving at a facility;
program code instructions configured to automatically assign the loads of the vehicle to one or more respective storage locations of the facility in response to receipt of the indication; and
program code instructions configured to enable provision of another indication to a communication device associated with the vehicle indicating the respective storage locations to place the corresponding loads.

20. The computer program product of claim 19, wherein enable provision of the another indication enables a driver of the vehicle to deliver the loads to the respective storage locations for storage of the loads.
